(19) United States
(12) Patent Application Publication
(10) Pub. No.: US 2014/0032268 A1
(43) Pub. Date: Jan. 30, 2014

(54) IDENTIFYING ITEMS AT DISPOSAL FOR GENERATING HOUSEHOLD CONSUMPTION DATA

(71) Applicants: Ezekiel Kruglick, Poway, CA (US); Angele Sjong, Louisville, CO (US)

(72) Inventors: Ezekiel Kruglick, Poway, CA (US); Angele Sjong, Louisville, CO (US)

(73) Assignee: Empire Technology Development LLC, Wilmington, DE (US)

(21) Appl. No.: 13/884,257

(22) PCT Filed: Jul. 24, 2012
(86) PCT No.: PCT/US12/47940

§ 371 Date: Sep. 26, 2013

(51) Int. Cl. G06Q 30/02

(52) U.S. Cl. CPC G06Q 30/0202
USPC 705/7.31

(57) ABSTRACT

Technologies are generally described for gathering household consumption data at product disposal and determining a household consumption behavior. Disposed items may be identified through various identification techniques such as optical image capture based identification, a barcode based identification, or a Radio Frequency Identification (RFID) tag based identification at a point of disposal by a collecting entity associated with additional information such as address, date/time of collection, etc. for a household consumption database. A household consumption behavior may be determined based on analysis of the household consumption database and a report of the household consumption behavior may be provided to business and legal entities for allowing the entities to use the household consumption data for targeting consumers for marketing, as well as for legal, and regulatory purposes.

### BACKGROUND

Unless otherwise indicated herein, the materials described in this section are not prior art to the claims in this application and are not admitted to be prior art by inclusion in this section.

Manufacturers and sellers of products are often interested in tracking consumer spending and product usage. Typically, consumer spending and product usage data may be gathered when consumer purchases items at the source, such in person at a retail store and online at various retail websites. Gathering consumer spending and product usage data at the source at the time of purchase can be difficult as there may be thousands of potential retailers for a product and it can be challenging and complicated to attempt to gather meaningful and normalized consumer data from the multiple sources. Additionally, the sellers may desire to track specific consumer product usage, and gathering consumer data at the time of purchase may not take into account when the purchase of a product is not necessarily the user of the product, such as when a consumer purchases a product as a gift. Further, some retailers may offer volume packaging which may hide consumer usage patterns. For example, the consumer may purchase a large quantity of a product at a retailer, but may only use a portion of the product, and thus the consumer product usage data may be misleading when collected from the retailer at the time of the purchase.

### SUMMARY

The present disclosure generally describes techniques for identifying items at disposal and generating a household consumption data for the identified items. According to some examples, the present disclosure describes a method for gathering household consumption data at product disposal. The method may include identifying a disposed product through one or more identification techniques at a point of disposal, determining an address associated with the disposed product, and associating the identified product with the determined address to obtain the household consumption data.

According to other examples, the present disclosure describes a system for gathering household consumption data at product disposal. The system may include one or more identification modules configured to capture identification information associated with a disposed product at a point of disposal and a processing module configured to identify the disposed product based on the captured identification information, determine an address associated with the disposed product, and associate a product disposal event with the determined address to obtain the household consumption data; and a communication module configured to provide the household consumption data to a processing server

According to further examples, the present disclosure also describes a method for gathering household consumption data. The method may include receiving the household consumption data from a collection system, where the household consumption data may be obtained by identifying a disposed product through one or more identification techniques at a point of disposal, determining an address associated with the disposed product, and associating a product disposal event with the determined address to obtain the household consumption data, determining a household consumption behavior based on the household consumption data, and providing the household consumption behavior to one or more entities

According to yet other examples, the present disclosure also describes an information processing system for gathering household consumption data. The system may include a server configured to receive the household consumption data from a collection system that is configured to identify a disposed product through one or more identification techniques at a point of disposal, determine an address associated with the disposed product, and associate a product disposal event with the determined address to obtain the household consumption data, determine a household consumption behavior based on the household consumption data, and provide the household consumption behavior to one or more entities

According to some examples, the present disclosure describes an information collection system for collecting product information at disposal. The system may include one or more item identification devices configured to identify one or more items through one or more identification techniques at a point of disposal, determine an address associate with the disposed items, and associate the identified items with the determined address, and a server configured to receive and process collected item and address information.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example scenario for a product lifecycle from purchase to disposal;

FIG. 2 illustrates example item identification of disposed items by one or more item identification devices;

FIG. 3 illustrates an example scenario for generating a household consumption database based on items collected at disposal;

FIG. 4 illustrates an example scenario for utilizing household consumption data to provide targeted marketing and advertising, according to embodiments;

FIG. 5 illustrates a general purpose computing device, which may be used to control a system for identifying items at disposal and generating a household consumption database;

FIG. 6 is a flow diagram illustrating an example method that may be performed by a computing device such as the computing device in FIG. 5; and

FIG. 7 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, among other things, to methods, apparatus, systems, devices, and/or computer program products related to gathering household consumption data at product disposal and determining a household consumption behavior.

Briefly stated, technologies are generally described for gathering household consumption data at product disposal and determining a household consumption behavior. Disposed items may be identified through various identification techniques such as optical image capture based identification, a barcode based identification, or a Radio Frequency Identification (RFID) tag based identification at a point of disposal by a collecting entity, associated with additional information such as address, date/time of collection, etc. for a household consumption database. A household consumption behavior may be determined based on analysis of the household consumption database and a report of the household consumption behavior may be provided to business and legal entities for allowing the entities to use the household consumption data for targeting consumers for marketing, as well as for legal, and regulatory purposes.

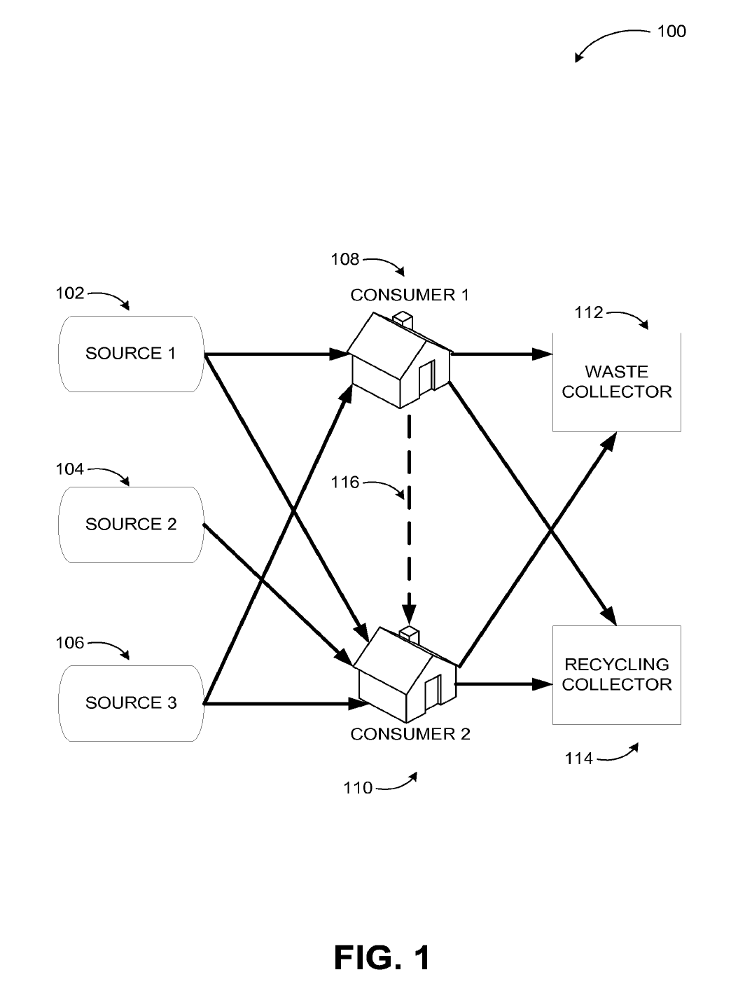

FIG. 1 illustrates an example scenario for a product lifecycle from purchase to disposal, arranged in accordance with at least some embodiments described herein. As demonstrated in diagram 100, consumers may purchase products from a variety of sources 102, 104, 106. A first consumer 108 may purchase products at a first source 102, which may be a large retail chain store, and the first consumer 108 may also purchase products from smaller local retail stores, and further, the first consumer 108 may purchase products from an online retail store. The first consumer 108 may purchase products for himself/herself, which the first consumer 108 may use in the first consumer's own home. Additionally, the first consumer 108 may purchase products for another consumer 110 such as a friend or family member as gifts, and in another scenario, the first consumer 108 may purchase products for another consumer 110 as a favor while at the store. Further, the first consumer 108 may purchase a product from the first source 102, and the first consumer 108 may then resell the product to another consumer 110. In the above example scenarios, products purchased by the first consumer 108 may be purchased from one of the multiple sources, and the products may then be consumed by the other consumer at the other consumer's home.

Businesses, merchants, and other entities may desire to track a consumer's purchases and actual consumption of purchased products, for marketing, advertising and other business purposes, however tracking the consumer's product consumption or household at the time and place of product purchase may be difficult and complicated as there may be a large quantity of products and product sources to monitor and track. Additionally, data for household consumption collected at the time and place of product purchase may be inaccurate and misleading, such as in a scenario when the consumer purchases a large quantity of a product but only uses a portion of the product, and also when the purchasing consumer is not the consuming consumer such as in a scenario when the first consumer 108 purchases products and transfers 116 the products to another consumer 110. Household consumption data gathered at the time and place of product purchase may not reflect these example scenarios and may not accurately indicate a consumer's true consumption of a product.

In a system according to embodiments, household consumption data may be gathered at the time and place of product disposal since product disposal patterns may more accurately indicate consumption patterns for a product. In a typical household consumption scenario, the first consumer 108 may purchase one or more products from multiple sources 102, 104, 106 including in person at local retail stores and online at various product websites. While products may be purchased from one of many sources, the first consumer 108 may actually use the product in a limited number of locations, such as the first consumer's home and workplace, with a likely majority of the household consumption occurring at the first consumer's home. When the first consumer 108 is finished with the product, the first consumer 108 may dispose of the used product in a disposal receptacle associated with the first consumer 108, which may be a waste bin and/or a recycle bin. The disposal receptacle may be processed by a single entity, such as a waste collector entity 112 and/or recycling collector entity 114, on a regular schedule, and the waste collector entity 112 and/or the recycling collector entity 114 may identify disposed of products in the disposal receptacle for indicating household consumption data.

In an example embodiment, household consumption data may be collected at the time of collection and processing of the disposal receptacle associated with the first consumer 108. Collecting the household consumption data at the time of processing of the disposal receptacle may provide comprehensive and more accurate household consumption data because the products collected from the disposal receptacle may indicate which products the first consumer has actually consumed during a recent time period. In an example scenario, the first consumer may purchase two bottles of shampoo during a buy-one-get-one free sale at a product source. Household consumption data collected at the time and place of purchase may indicate that the first consumer 108 consumed two bottles of shampoo this time period, such as this month for example. In actuality, the first consumer 108 may only use one bottle of shampoo during this time period and may then use the second bottle of shampoo during a subsequent time period. When the first consumer 108 disposes of the first bottle of shampoo in the disposal receptacle, the processing entity, such as the waste collector entity 112 and/or recycling collector entity 114 may process the disposal receptacle and identify that the first consumer 108 only used one bottle of shampoo this month, which more accurately reflects the consumer's household consumption.

In another example scenario, the first consumer 108, such as a grandmother, may purchase a product for a second consumer, the grandmother's daughter. The grandmother may purchase a number of baby items at a product source 106 for the daughter's baby, and the grandmother may transfer 116 the products to the daughter, such that the baby items may be consumed at the daughter's house. Gathering household consumption data at the time of purchase of the baby items may inaccurately indicate that the grandmother has a new baby, and the grandmother may receive baby information and merchandise from marketing companies and businesses based on this inaccurate prediction. However, gathering the household consumption data at the time of product disposal may more accurately indicate that the daughter has a new baby and may be interested in receiving baby related marketing materials. For example, when the daughter has finished with the baby items, the daughter may dispose of the baby items and/or baby item packaging in a disposal receptacle at the daughter's house. The processing entity, such as the waste collector entity 112 and/or the recycling collector entity 114 may process the disposal receptacle at the daughter's house and may identify the disposed baby items. Based on the baby items retrieved and processed from the disposal receptacle at the daughter's house, household consumption data may be generated that accurately reflects the transfer 116 of the purchased products from the purchasing consumer, the grandmother, to the actual consuming consumer, the daughter. Based on the household consumption data for the daughter, the daughter may receive beneficial baby information, marketing, and advertising materials from various business, marketing and advertising agencies.

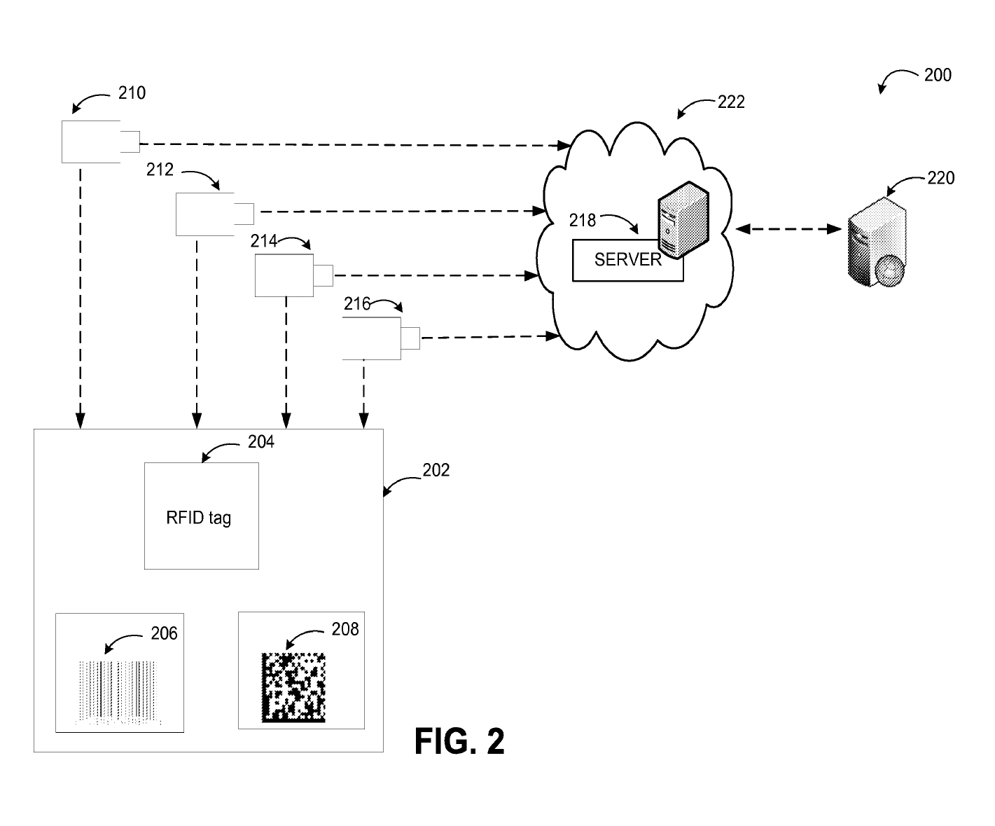

FIG. 2 illustrates example item identification of disposed items by one or more item identification devices, arranged in accordance with at least some embodiments described herein. As illustrated in diagram 200, household consumption data may be gathered at the time and place of product disposal in order to determine a household consumption behavior. When a consumer has finished with a product, and/or the product packaging, the consumer may dispose of the product and/or product packaging in a disposal receptacle associated with the consumer's home. The disposal receptacle may be a waste bin and/or a recycle bin, which may be collected and processed by a collecting entity, which may be a waste collector entity and/or a recycling collector entity, on a regular schedule.

In a system according to embodiments, the collecting entity may identify disposed products in the disposal receptacle at the time of collection, and may gather data associated with the disposed products, including time, date and location information for generating household consumption data. The collecting entity may use multiple item recognition techniques to identify disposed products in the disposal receptacle. Some example item recognition techniques may include optical image capture based identification, a barcode based identification, a QR code based identification, and a Radio Frequency Identification (RFID) tag based identification.

In an example embodiment, contents of the disposal receptacle may be placed on a belt within a collection truck equipped with the item recognition technologies when the collecting entity collects and processes the disposed products from the disposal receptacle. An optical image capture device 210 may capture an image of the disposed products and using image recognition techniques, the optical image capture device 210 may analyze the disposed products and specifically identify each of the disposed products based on identifying physical features of the disposed products. Image processing may be performed by another device. For example, photos may be stored with meta information and processed later or the photos may be sent to a data processing center. Additionally, a barcode scanner 212 may read barcodes 206 on disposed products in the disposal receptacle 202. The barcode scanner 212 may read the actual barcodes 206 on the disposed products as they are collected in the collection truck, and additionally the barcode scanner 212 may read the barcodes 206 from an image captured by optical image capture device 210. The barcode scanner 212 may provide specific disposed product identification information by obtaining a UPC product code from a UPC database. Likewise, a QR scanner 214 may read QR codes 208 on disposed products in the disposal receptacle 202. The QR scanner 214 may read the actual QR codes 208 on the disposed products as they are collected in the collection truck, and additionally the QR scanner 214 may read the QR codes 208 from an image captured by optical image capture device 210.

During or following the collection of the disposal receptacle 202 by the collecting entity, the collecting entity may use an RFID reader 216 to identify disposed products in the disposal receptacle 202. The RFID reader 216 may scan the disposal receptacle 202, and any disposed products that have an RFID tag 204 may be identified by the RFID reader 216. The RFID reader 216 may be configured to read multiple tags simultaneously, such that the RFID reader may be able to identify multiple disposed products in the disposal receptacle 202 concurrently while the disposed products are placed on the collection truck.

In an example embodiment, the collecting entity may use two or more of the identification techniques simultaneously in order to collect comprehensive and accurate product identification information. For example, if a portion of the product or product packaging including the barcode is hidden or damaged, the RFID scanner 216 and the optical image capture device 210 may also collect identification information. In an example scenario, the collecting entity may perform RFID tag scanning while emptying the disposal receptacle 202 onto the truck, and while in transit to the next disposal pick up site, the collecting entity may perform barcode, QR code scanning, and/or image capture identification techniques.

In an additional embodiment, the disposed products identification may be performed in real time during collection of the disposed products from the disposal receptacle, and the disposed products identification may be sent via a server 218 over a network 222 to a central processing system 220 for collecting and organizing the disposed products identification information. In another example embodiment, the optical image capture device 210 may transmit images of the disposed products via the server 218 over the network 222 to the central processing system 220 for processing the images and identifying the disposed products. Images may also be tagged with location, date, etc. and processed later. Additionally data retrieved from the barcode scanner 212, the QR scanner 214 and/or the RFID scanner 216 may also be transmitted via the server 218 over the network 222 to the central processing system 220 for processing the data for remote identification of the disposed products at the central processing system 220.

In a further embodiment, upon collection of the disposed products from the disposal receptacle 202 at the disposal site, the collecting entity may additionally identify the location and time/date information of the collection. The disposal site may be associated with the consumer's home and/or workplace, and additionally the disposal site may be associated with a school, business entity, and/or other non-business entity. Upon collection of the disposed products, the location information may be determined and associated with the identified disposed products. The location information may include the address of the disposal site, and may also include additional data, such as a neighborhood, postal code, city, county, advertising coverage area, delivery area, etc. The location information may be manually input by the collecting entity, and in another embodiment, the collecting entity may use a Global Positioning Service (GPS) or other geocoding location determination technique to determine the location of the disposal receptacle at the disposal site. The receptacle itself may also have coding indicating which owner it is associated with, enabling the owner to be unambiguously identified even in situations where receptacles are placed densely together.

Further, upon collection of the disposed products, the time and date information may be determined and associated with the identified disposed products. The time and date information may be a timestamp with the specific time and date of collection associated with the identified disposed products. In another embodiment, the time and date information may include a week number, for example in a scenario when the collecting entity collects disposed products on a weekly schedule and may identify the time based on the collection week. The collecting entity may provide the identification information of the disposed products identified in the disposal receptacle, along with associated location, time and date information to the central processing system 220 for generating a household consumption database. The household consumption database may include a list of identified disposed products, the location of the disposed products, and the time and date when the disposed products were collected. Based on the household consumption database, a pattern of consumption habits may be determined for each disposal site location.

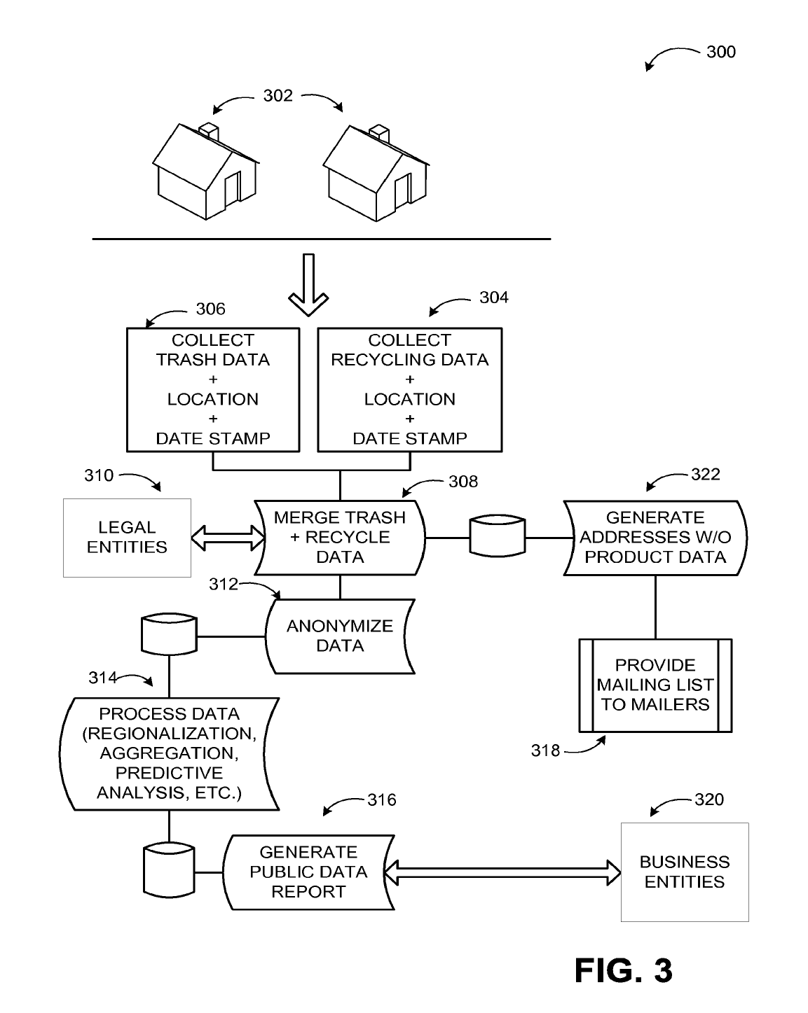

FIG. 3 illustrates an example scenario for generating a household consumption database based on items collected at disposal, arranged in accordance with at least some embodiments described herein. As demonstrated in diagram 300, household consumption data may be gathered at the time and place of product disposal in order to determine household consumption behavior. When a consumer is finished with a product and/or the product packaging, the consumer may dispose of the product and/or product packaging in one or more disposal receptacles at a disposal site 302 associated with the consumer, which may be the consumer's home or workplace for example. Example disposal receptacles may include a waste bin and/or a recycle bin associated with the disposal site 302. A collection entity such as a waste collector entity may collect trash data 306 for the disposed products collected from the waste bin, and a recycling collector entity may collect recycling data 304 for disposed products collected from the recycling bin associated with the consumer's home 302 for identifying the disposed products in the disposal receptacle.

As previously described, the collection entity may use a number of identification techniques to identify each of the disposed products in the disposal receptacles, including optical image capturing, barcode scanning, QR code scanning, and RFID tag reading. Additionally, upon collection of the disposed products from the disposal receptacles at the disposal site 302, the collection entity may also determine location and time and date information associated with the collection of the disposed products, such that the collected trash data 306 and collected recycling data 304 may also include identification of each of the disposed products along with associated location, time, and date data associated with each disposal site 302.

Upon collection of the trash data 306 and recycling data 304 from the disposal receptacles including the identification of the disposed products and the location and time/date information associated with the disposed products at the disposal site, the trash data 306 and recycling data 304 may be merged 308 as household consumption data in a household consumption database. While the trash data 306 and recycling data 304 may be merged 308 as household consumption data, the household consumption database may also include whether the disposed products were collected from the waste bin or the recycling bin. The household consumption data in the household consumption database may be used for observing consumer consumption at disposal sites 302 and determining a pattern of household consumption behavior based on the types of disposed products identified at the disposal sites 302.

In an example embodiment, the household consumption data in the database may be processed 314 utilizing data mining and predictive analysis techniques for identifying a pattern of consumer consumption associated with the location of the disposal receptacles, and determining household consumption behavior of one or more consumers associated with the disposal receptacle location. A pattern of consumption habits for a specific address may be determined based on processing the household consumption database for the specific address of the disposal site and identifying the types of disposed products collected at the disposal site. The household consumption data in the database may be additionally be processed and sorted according to various criteria, such as for example, the type of the disposed product, the retrieval location of the disposed product, or the date of collection of the disposed product, and additionally may be processed and sorted according to known or observed consumer demographics.

In another example embodiment, a household consumption report 316 may be generated based on the processed household consumption data for providing information about determined household consumption behavior according to the selected criteria. For example, the processed household consumption data may indicate that a specific address frequently disposes golf related items, which may indicate that the consumer associated with the specific address has in interest in golf, and possibly other sports. In a further example, the processed household consumption data may indicate that at another specific address, multiple children's items have been disposed of which may indicate that the household at that address may include one or more children. Further, the household consumption report 316 may be sorted according to specific types of products, product brands, and product attributes for providing more targeted household consumption behavior. For example, the household consumption report 316 may identify specific types and brands of products for indicating brand preferences of consumers associated with a disposal site. Trend or associative techniques may also be used, in one example using collaborative filtering to determine that households that consume certain products typically consume other certain products, or to determine that a rise in one sort of consumption accompanies a decrease in another.

In yet another example embodiment, upon processing 314 the household consumption database and generating the household consumption report 316, the household consumption report 316 may be provided to one or more business entities 320 for allowing the business entities 320 to use the information provided in the household consumption report for the business entity's purposes. Some example entities may include businesses, marketing and advertising entities, and government and regulatory agencies. Businesses, marketing, and advertising entities may be interested in the household consumption behavior for targeting consumers for receiving product incentives, advertising and marketing materials. For example, based on the household consumption report 316, a consumer who has demonstrated an interest in golf may be identified and may be selected to receive targeted mailings for golf-related products, or for goods and services that are appropriate for golfers. Legal/regulatory entities may use the data to monitor recycling patterns, compliance with regulations, and so on.

In an additional embodiment, based on the household consumption report, a change in the pattern of consumption habits for the address may be determined, and based on the change in the consumption habits, a change or event may be inferred for the address. For example, identified products in the disposal receptacles may indicate that a consumer at the address has stopped consuming meat products and has begun consuming only non-meat products. Based on the change in household consumption determined by the disposed products in the disposal receptacles, it may be inferred that the consumer at the address has become a vegetarian, and the vegetarian consumer may be targeted for receiving marketing and advertising materials from vegetarian associated entities.

In an example embodiment, before providing the household consumption report to business entities 320 for advertising and marketing purposes, the household consumption data may be anonymized 312 such that the specific location information may not include detailed or specific consumer information, in order to protect consumer privacy and identity. The household consumption data may also be regionalized such that the location information may be provided based on location regions, including neighborhoods, postal codes, cities, and/or counties, in order to protect consumer privacy. Example regionalized data may indicate a neighborhood which may include multiple families with children based on identified children's products in the disposal receptacles associated with the neighborhood. Additionally, the consumers may be able to opt-out at the anonymization 312 stage, such that consumers may be able to set filters to prevent the conveying of household consumption data for advertising and marketing use by business entities 320. The consumers may not be able to opt-out of providing data for governmental and regulatory purposes.

In a further example embodiment, the household consumption database may also be provided to legal entities 310 for governmental, legal and regulatory purposes. Legal entities 310, such as government and regulatory entities, may be interested in identifying disposed products in disposal receptacles which may indicate illegal activities, such as a drug or bomb manufacturing facility. Additionally, the government and regulatory agencies may use the household consumption database to indicate health outbreaks. For example, the household consumption database may indicate a large consumption of flu medication within a localized area which may indicate an outbreak. Additionally, the household consumption database may be used to ensure recycling and waste ordinances are being obeyed within certain regions. If products are being disposed of incorrectly or if ordinances are being violated, the household consumption database could be used to levy fines for violations and incorrect product disposal by individual consumers and also by the collection entities. The household consumption database may not be anonymized when providing to the legal entities 310 since the legal entities may need to know specific location and consumer information for legal and regulatory purposes.

In an additional embodiment, based on the household consumption database, one or more target consumers may be identified for receiving product information and materials, and a list of addresses for the target consumers may be generated 322 without the household consumption data. The list of addresses for the targeted consumers may be provided 318 to a third party mailer, who may use the list to send promotions and advertisements to the selected consumers on behalf of business entities and product manufacturers. The address list generation 322 may be performed at any point, for example, after processing 314 or business report generation 316.

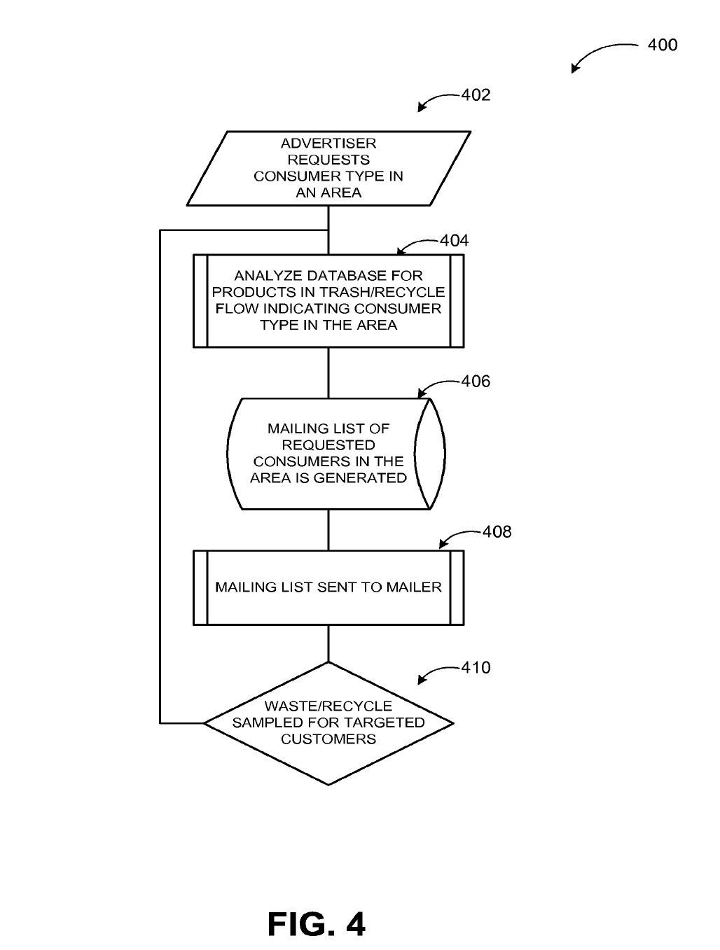

FIG. 4 illustrates an example scenario for utilizing household consumption data to provide targeted marketing and advertising, according to embodiments, arranged in accordance with at least some embodiments described herein. As described above in conjunction with FIG. 3, a household consumption report may be generated based on the processed household consumption data for providing information about determined household consumption behavior. A business entity, such as an advertiser, product manufacturer, or marketing company may desire to identify specific targeted consumers for mailing targeted product information, incentives, marketing and advertising materials.

In an example embodiment shown in diagram 400, the business entity may request 402 a household consumption database analysis to identify a specific type of consumer based on observed household consumption behavior within a region, such as a neighborhood, zip code, advertising coverage area, delivery area, city and or county. The household consumption database may be analyzed 404 according to the requested criteria, which may include a type of product, brand of product, specific product attributes, type and location of disposal site, and a time and date of collection. The database analysis may generate 406 a list of addresses of disposal sites where disposed products meeting the requested criteria have been identified. The mailing list of addresses meeting the requested criteria may be sent to a third party mailer, who may send out the targeted product information, incentives, marketing and advertising materials on behalf of the requesting business entity. Additionally, after the product marketing and advertising materials have been mailed out to the targeted consumers from the mailing list, the business entity may request additional analysis of the household consumption database to identify if any of the targeted consumers have taken advantage of the mailed product information, incentives, marketing and advertising materials and have become targeted customers 410, for example.

In an example scenario a baby formula company may desire to identify consumers within a particular zip code for sending baby formula coupons and marketing materials. The baby formula company may request a household consumption report identifying one or more consumers within the zip code whose determined household consumption behavior may indicate that there is a new baby in the household. The household consumption database may be analyzed to identify household items where baby items, such as diapers, baby toys, and other baby products have been disposed or any other products that may indicate a baby is on the way or present. Based on the database analysis according to the requested criteria, the household consumption report may be generated providing a list of addresses of consumers who likely have a new baby. Based on this information, the list of addresses may be provided to the baby formula company and/or to a third party mailer who may send the baby formula coupons and marketing materials to the addresses included on the mailing list. Additionally, after the baby formula coupons and marketing materials have been mailed out to targeted consumers, the baby formula company may request to analyze household consumption database again to determine if any of the targeted consumers disposed of the baby formula company's product, indicating that the targeted consumers have tried the baby formula company's product in response to the received coupons and materials.

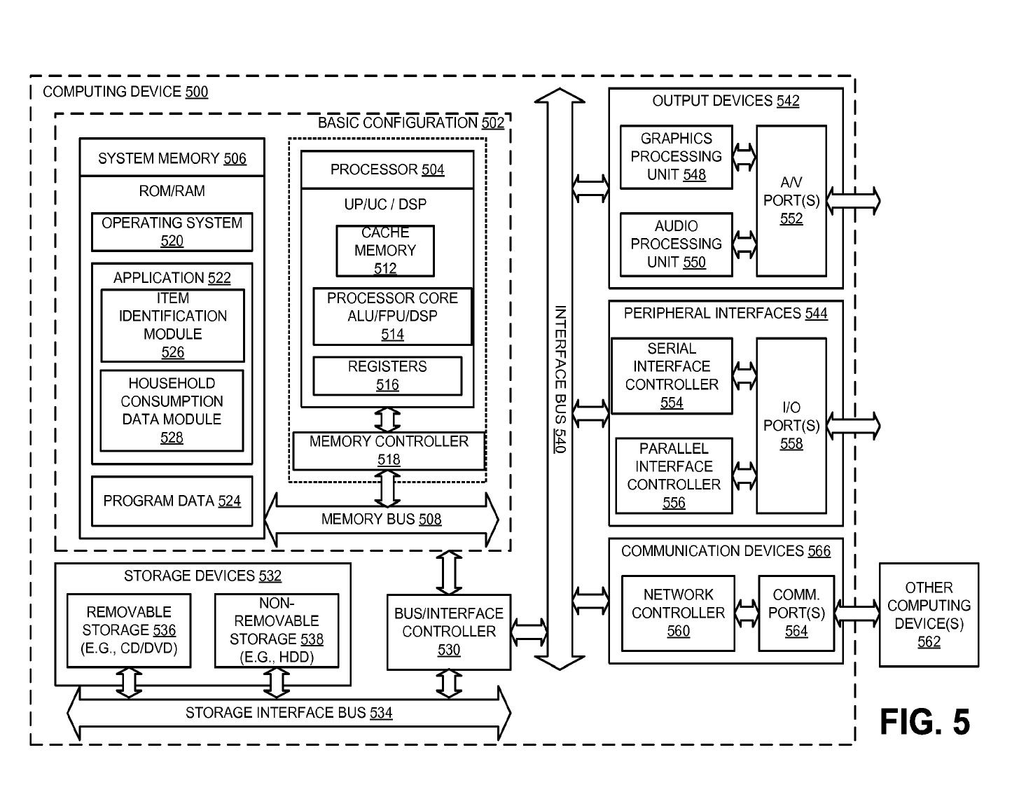

FIG. 5 illustrates a general purpose computing device, which may be used to control a system for identifying items at disposal and generating a household consumption database, arranged in accordance with at least some embodiments described herein. In a very basic configuration 502, a computing device 500 typically includes one or more processors 5504 and a system memory 506. A memory bus 508 may be used for communicating between a processor 504 and system a memory 506.

Depending on the desired configuration, the processor 504 may be of any type including but not limited to a microprocessor (μP), a microcontroller (μC), a digital signal processor (DSP), or any combination thereof. The processor 504 may include one more levels of caching, such as a level cache memory 512, a processor core 514, and one or more registers 516. An example processor core 514 may include an arithmetic logic unit (ALU), a floating point unit (FPU), a digital signal processing core (DSP Core), or any combination thereof. An example memory controller 518 may also be used with the processor 504, or in some implementations the memory controller 518 may be an internal part of the processor 504.

Depending on the desired configuration, the system memory 506 may be of any type including but not limited to volatile memory (such as RAM), non-volatile memory (such as ROM, flash memory, etc.) or any combination thereof. The system memory 506 may include an operating system 520, one or more applications 522, and program data 524. The application 522 may include an item identification module 526 that is arranged to identify disposed products at recycle and waste bins at the point of disposal. The application 522 may also include a household consumption data module 528 that is arranged to gather and process household consumption data for the identified disposed products based on predefined criteria and determine a household consumption behavior based on the collected household consumption data. Program data 524 may include disposed products data, date and time data, location data, consumer data, and similar data. The program data 524 may be useful in processing the household consumption data to determine a pattern of consumer habits of product consumption. This described basic configuration 502 is illustrated in FIG. 5 by those components within the inner dashed line.

The computing device 500 may have additional features or functionality, and additional interfaces to facilitate communications between the basic configuration 502 and any required devices and interfaces. For example, a bus/interface controller 530 may be used to facilitate communications between the basic configuration 502 and one or more data storage devices 532 via a storage interface bus 534. The data storage devices 532 may be removable storage devices 536, non-removable storage devices 538, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 506, removable storage devices 536 and non-removable storage devices 538 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (e.g., output devices 542, peripheral interfaces 544, and communication devices 546) to the basic configuration 502 via the bus/interface controller 530. Example output devices 542 include a graphics processing unit 548 and an audio processing unit 550, which may be configured to communicate to various external devices such as a display or speakers via one or more A/V ports 552. Example peripheral interfaces 544 include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 546 includes a network controller 560, which may be arranged to facilitate communications with one or more other computing devices 562 over a network communication link via one or more communication ports 564.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 500 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 500 may also be implemented as a personal computer including both laptop computer and non-laptop computer configurations. Moreover the computing device 500 may be implemented as a networked system or as part of a general purpose or specialized server.

Example embodiments may also include methods. These methods can be implemented in any number of ways, including the structures described herein. One such way is by machine operations, of devices of the type described in the present disclosure. Another optional way is for one or more of the individual operations of the methods to be performed in conjunction with one or more human operators performing some of the operations while other operations are performed by machines. These human operators need not be collocated with each other, but each can be only with a machine that performs a portion of the program. In other examples, the human interaction can be automated such as by pre-selected criteria that are machine automated.

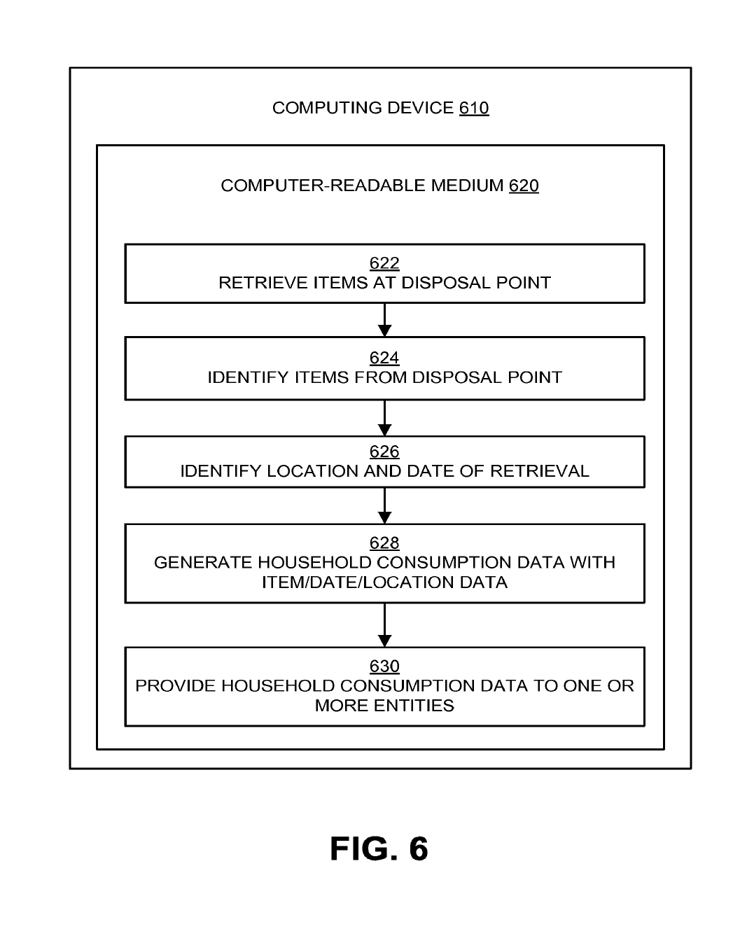

FIG. 6 is a flow diagram illustrating an example method that may be performed by a computing device such as the computing device in FIG. 6, arranged in accordance with at least some embodiments described herein.

Example methods may include one or more operations, functions or actions as illustrated by one or more of blocks 622, 624, 626, 628 and/or 630. The operations described in blocks 622 through 630 may also be stored as computer-executable instructions in a computer-readable medium such as a computer-readable medium 620 of a computing device 610.

A process for gathering household consumption data at product disposal and determining a household consumption behavior may begin with block 622, “RETRIEVE ITEMS AT DISPOSAL POINT.” At block 622, items may be retrieved at a disposal site from a waste bin and/or a recycle bin. A disposal site may be associated with a consumer household, a school, a business, or other non-business entity, for example.

Block 622 may be followed by block 624, “IDENTIFY ITEMS FROM DISPOSAL POINT.” At block 624, upon retrieval of the items at the disposal site, the retrieved items may be identified. The retrieved items may be identified utilizing multiple identification techniques, such as optical image capture based identification, barcode based identification, QR code based identification and RFID tag based identification.

Block 624 may be followed by block 626, “IDENTIFY LOCATION AND DATE OF RETRIEVAL.” At block 626, the location and the date of the retrieval of the items at the disposal site may be identified. The location may include an address of the disposal site, and may also include a region of the disposal site, such as a neighborhood, postal code, city, and county where the disposal site is located. The date and time information may include a specific date and time, which may be a timestamp of when the items are retrieved. The date and time information may also include a time range number, such as a week number, corresponding to a regular waste retrieval schedule.

Block 626 may be followed by block 628, “GENERATE HOUSEHOLD CONSUMPTION DATA WITH ITEM/DATE/LOCATION DATA.” At block 628, household consumption data for the retrieved items may be generated. The household consumption data may include the identification information for each item retrieved at the disposal site, and may also include the location, date, and time information associated with each retrieved item. A household consumption behavior may be determined based on the generated household consumption data. Additionally, a report of the household consumption behavior may be generated based on the household consumption data.

Block 628 may be followed by block 630, “PROVIDE HOUSEHOLD CONSUMPTION DATA To ONE OR MORE ENTITIES.” At block 628, the household consumption data may be provided to one or more entities for allowing the entities to use the household consumption data for the entity's purposes. The entities may include businesses, a marketing entity, a government agency, and other non-government agencies, which may use the household consumption data for marketing, legal, and regulatory purposes, for example.

The blocks included in the above described process are for illustration purposes. Gathering household consumption data at product disposal and determining a household consumption behavior may be performed by similar processes with fewer or additional blocks. In some examples, the blocks may be performed in a different order. In some other examples, various blocks may be eliminated. In still other examples, various blocks may be divided into additional blocks, or combined together into fewer blocks. Although illustrated as sequentially ordered operations, in some implementations the various operations may be performed in a different order, or in some cases various operations may be performed at substantially the same time.

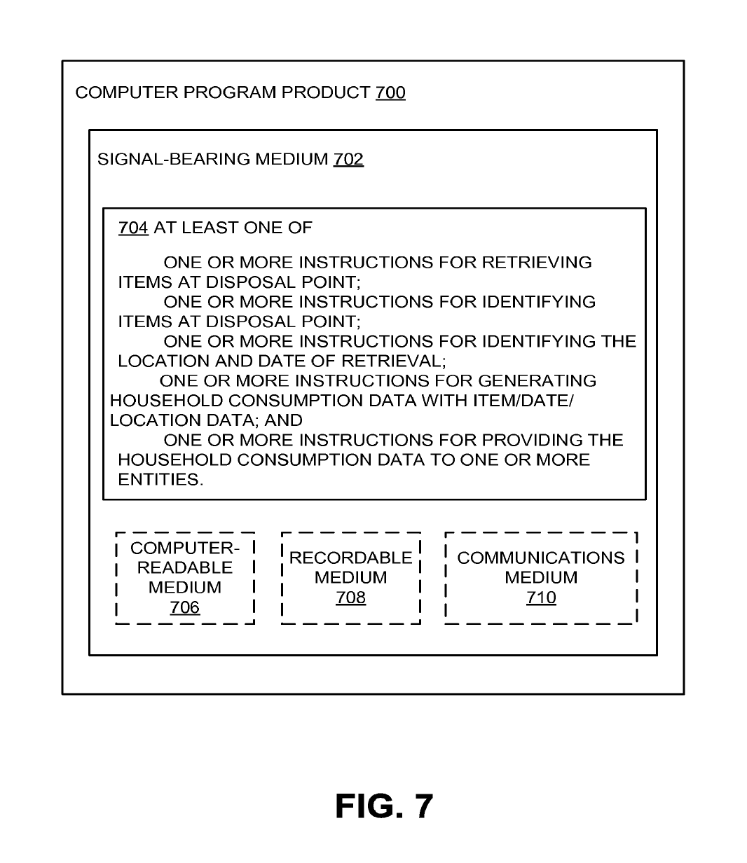

FIG. 7 illustrates a block diagram of an example computer program product, all arranged in accordance with at least some embodiments described herein. In some examples, as shown in FIG. 7, a computer program product 700 may include a signal bearing medium 702 that may also include machine readable instructions 704 that, when executed by, for example, a processor, may provide the functionality described above with respect to FIG. 5 and FIG. 5. Thus, for example, referring to the processor 504, the item identification module 526 and the household consumption data module 528 may undertake one or more of the tasks shown in FIG. 5 in response to the instructions 704 conveyed to the processor 504 by the signal bearing medium 702 to perform actions associated with gathering household consumption data at product disposal and determining a household consumption behavior as described herein. Some of those instructions may include retrieving items at a disposal point, identifying items at the disposal point, identifying the location and date of the retrieval, generating household consumption data with item/date/location data, and providing the household consumption data to one or more entities.

In some implementations, the signal bearing medium 702 depicted in FIG. 7 may encompass a computer-readable medium 706, such as, but not limited to, a hard disk drive, a Compact Disc (CD), a Digital Versatile Disk (DVD), a digital tape, memory, etc. In some implementations, the signal bearing medium 702 may encompass a recordable medium 708, such as, but not limited to, memory, read/write (R/W) CDs, R/W DVDs, etc. In some implementations, the signal bearing medium 702 may encompass a communications medium 710, such as, but not limited to, a digital and/or an analog communication medium (e.g., a fiber optic cable, a waveguide, a wired communications link, a wireless communication link, etc.). Thus, for example, the program product 700 may be conveyed to one or more modules of the processor 504 by an RF signal bearing medium, where the signal bearing medium 702 is conveyed by a wireless communications medium 710 (e.g., a wireless communications medium conforming with the IEEE 802.11 standard).

According to some embodiments, the present disclosure describes a method for gathering household consumption data at product disposal. The method may include identifying a disposed product through one or more identification techniques at a point of disposal, determining an address associated with the disposed product, and associating a product disposal event with the determined address to obtain the household consumption data.

According to some examples the identification techniques may include an optical image capture based identification, a barcode based identification, a QR code based identification, or a Radio Frequency Identification (RFID) tag based identification. The point of disposal may include one of: a recycle bin or a waste bin. The point of disposal may be associated with one of: a personal residence, a school, a business, or a non-business entity.

The method may also include determining the address through one of: a manual entry, a Global Positioning Service (GPS) based automatic determination, an identifier of a disposal receptacle associated with the address, or geocoding a location of the point of disposal. The method may also include including date and/or time information in the obtained household consumption data. The method may also include including whether the disposed product is identified in a recycle bin or a waste bin in the obtained household consumption data.

According to other examples, the method may include anonymizing the household consumption data, and the method may also include processing the household consumption data according to predefined criteria, wherein the predefined criteria includes one or more of: a type of the product, a location of the product, and a date of product collection. Processing the household consumption data may include one or more of data mining and performing predictive analysis.

According to other examples, the method may include determining a pattern of consumption habits from processing a plurality of product disposal events for the address for the address. The method may also include determining a change in the pattern of consumption habits for the address, and inferring a change event for the address based on the determined change in the pattern of consumption habits. The method may also include determining product attribute information, and including the product attribute information in the household consumption data.

According to some embodiments, a system is provided for gathering household consumption data at product disposal. The system may include one or more identification modules configured to capture identification information associated with a disposed product at a point of disposal and a processing module configured to identify the disposed product based on the captured identification information, determine an address associated with the disposed product, and associate a product disposal event with the determined address to obtain the household consumption data; and a communication module configured to provide the household consumption data to a processing server.

According to some examples the identification techniques may include an optical image capture based identification, a barcode based identification, a QR code based identification, or a Radio Frequency Identification (RFID) tag based identification. The point of disposal may include one of: a recycle bin or a waste bin. The point of disposal may be associated with one of: a personal residence, a school, a business, or a non-business entity.

According to some examples, the processing module may be configured to determine the address through one of: a manual entry, a Global Positioning Service (GPS) based automatic determination, an identifier of a disposal receptacle associated with the address, or geocoding a location of the point of disposal.

According to other examples, the processing module may be configured to include date and/or time information in the obtained household consumption data. The processing module may also be configured to include whether the disposed product is identified in a recycle bin or a waste bin in the obtained household consumption data. The processing module may also be configured to anonymize the household consumption data.

According to other examples, the processing module may be configured to process the household consumption data according to predefined criteria, wherein the predefined criteria includes one or more of: a type of the product, a location of the product, and a date of product collection. The processing module may also be configured to process the household consumption data including one or more of data mining and performing predictive analysis. The processing module may also be configured to determine a pattern of consumption habits from processing a plurality of product disposal events for the address for the address.

According to other examples, the processing module may be configured to determine a change in the pattern of consumption habits for the address, and infer a change event for the address based on the determined change in the pattern of consumption habits. The processing module may also be configured to determine product attribute information, and include the product attribute information in the household consumption data.

According to further examples, a method is provided for gathering household consumption data. The method may include receiving the household consumption data from a collection system, where the household consumption data may be obtained by identifying a disposed product through one or more identification techniques at a point of disposal, determining an address associated with the disposed product, and associating a product disposal event with the determined address to obtain the household consumption data, determining a household consumption behavior based on the household consumption data, and providing the household consumption behavior to one or more entities.

According to further examples the identification techniques may include an optical image capture based identification, a barcode based identification, a QR code based identification, or a Radio Frequency Identification (RFID) tag based identification. The point of disposal may include one of: a recycle bin or a waste bin.

According to further examples, the method may include anonymizing the household consumption data, and the method may also include regionalizing the household consumption data based on location regions. The location regions may include one or more of: neighborhoods, postal codes, cities, and counties.

According to further examples, the method may include processing the household consumption data according to predefined criteria, wherein the predefined criteria includes one or more of: a type of the product, a location of the product, and a date of product collection. Processing the household consumption data may include one or more of data mining and performing predictive analysis. According to some examples, the method may include determining a pattern of consumption habits from processing a plurality of product disposal events for the address for the address.

According to further examples, the method may include determining a change in the pattern of consumption habits for the address, and inferring a change event for the address based on the determined change in the pattern of consumption habits. The entities may include a business, a marketing organization, a non-governmental regulatory agency, or a government agency.

According to further examples, the method may include identifying one or more target consumers for a product based on the household consumption behavior. The method may also include including a list of the one or more target consumers for the product with the household consumption behavior. The method may also include allowing consumers to opt out from having their products identified at the point of disposal.

According to some embodiments, the present disclosure also describes an information processing system for gathering household consumption data. The system may include a server configured to receive the household consumption data from a collection system that is configured to identify a disposed product through one or more identification techniques at a point of disposal, determine an address associated with the disposed product, and associate a product disposal event with the determined address to obtain the household consumption data, determine a household consumption behavior based on the household consumption data, and provide the household consumption behavior to one or more entities.

According to some embodiments, the collection system may be configured to identify the disposed product through one or more identification modules including an optical image capture module, a barcode/QR code reader, or a Radio Frequency Identification (RFID) interrogator. The point of disposal may include one of: a recycle bin or a waste bin.

According to some embodiments, the server may be further configured to anonymize the household consumption data. The server may be further configured to regionalize the household consumption data based on location regions. The location regions may include one or more of: neighborhoods, postal codes, cities, and counties.

According to some embodiments, the server may be further configured to process the household consumption according to predefined criteria, wherein the predefined criteria includes one or more of: a type of the product, a location of the product, and a date of product collection. The server may be further configured to process the household consumption data including one or more of data mining and performing predictive analysis. The server may be further configured to determine a pattern of consumption habits from processing the household consumption data for the address. The server may be further configured to determine a change in the pattern of consumption habits for the address, and infer a change event for the address based on the determined change in the pattern of consumption habits. The entities may include a business, a marketing organization, a non-governmental regulatory agency, or a government agency.

According to other embodiments, the server may be further configured to identify one or more target consumers for a product based on the household consumption behavior. The server may be further configured to include a list of the one or more target consumers for the product with the household consumption behavior. The server may be further configured to allow consumers to opt out from having their products identified at the point of disposal.

According to further embodiments, the present disclosure describes an information collection system for collecting product information at disposal. The system may include one or more item identification devices configured to identify one or more items through one or more identification techniques at a point of disposal, determine an address associate with the disposed items, and associate the identified items with the determined address, and a server configured to receive and process collected item and address information.

According to other embodiments, the one or more item identification devices may include an image capturing and processing device, a barcode and/or a QR code reader, or an RFID interrogator. The address may be determined through one of: a manual entry, a Global Positioning Service (GPS) based automatic determination, an identifier of a disposal receptacle associated with the address, or geocoding a location of the point of disposal. The server may be further configured to generate a household consumption report based on the collected item and address information.

According to other embodiments, the server may be further configured to include date and/or time information in the generated household consumption report. The server may be further configured to include whether the disposed item is identified in a recycle bin or a waste bin in the generated household consumption report. The server may be further configured to provide the household consumption report to one or more entities for allowing the one or more entities to use the household consumption report data for one or more of: marketing, legal, and regulatory purposes. The server may be further configured to allow consumers to opt out from having their items identified at the point of disposal.

According to other embodiments, the server may be further configured to anonymize the household consumption report. According to other embodiments, the server may be further configured to regionalize the household consumption report based on location regions. The location regions may include one or more of: neighborhoods, postal codes, cities, and counties. The point of disposal may include one of: a recycle bin or a waste bin. The point of disposal may be associated with one of: a personal residence, a school, a business, or a non-business entity

### EXAMPLES

Following are illustrative examples of how some embodiments may be implemented, and are not intended to limit the scope of embodiments in any way.

### Example 1

### Targeted Marketing Based on Consumer Behavior Identification

A video game manufacturer may desire to identify households who would likely respond to video game advertising and coupons. The video game manufacturer may request a household consumption report to be generated in order to identify household consumption behavior, which may indicate likely video game users. The household consumption database may be analyzed according criteria such as types of disposed products identified in disposal receptacles in a specific neighborhood. The household consumption database may be specifically analyzed to identify households disposing of products which may indicate video game users, such as game console packaging, other video game packaging, large television packaging, video game magazines, and other products which may indicate consumers within the household matching a likely video game player demographic. After analysis of the household consumption database, the household consumption report may be generated including a list of households within the requested area whose behavior indicates likely video game users. The video game manufacturer may then send targeted mailings such as coupons and advertising materials to the addresses on the list so that the targeted mailings may be sent to consumers likely to benefit from the received mailings, and also to ensure time and money is not wasted on sending targeted mailings to consumers who may not have any interest in video game materials and coupons.

### Example 2

### Using Multiple Identification Techniques to Determine Items at Disposal

A recycling collector entity may collect multiple disposed products from a recycling bin at a consumer's home. Upon emptying the contents of the recycling bin onto the recycling truck, a barcode scanner may scan the disposed products for exposed barcodes imprinted on the disposed products. The barcode scanner may identify a men's fitness magazine, a home decorating magazine, and children's brand cereal boxes. The recycling collector entity may also take a picture of the contents of the recycling content when the contents are emptied onto the truck. The image of the contents along with the results of the barcode scanning, and location and date and time information may be sent to a third party aggregator who may process the data. Using optical image recognition, an additional men's health magazine and some toy packaging may be identified. The third party aggregator may process the data to generate a database of products, location, and time and date data. The third party aggregator may generate a household consumption report which may indicate that a family lives at the identified home based on the identified products in the recycling bin. The third party aggregator may provide the household consumption report to product manufacturers, advertisers, marketers, and legal entities who may use the report to target the family for receiving product incentives and materials. Additionally the legal entities may use the report to monitor legal and regulated activities.

### Example 3

### Generating Mailing Lists Based on Household Consumption Analysis at Disposal

### Example 3

A dog food manufacturer may want to target consumers within a selected area with new dogs for sending advertising materials and coupons. The dog food manufacturer may request a household consumption report that analyzes the household consumption database for new dog products, such as puppy dog food empty containers, puppy diaper packages, small sized puppy beds, and puppy toys, for example, within a particular zip code. The household consumption report may include a list of addresses within the requested zip code that have recently disposed of new dog items in the disposal receptacles. Based on this information, the list of addresses may be provided to the dog food manufacturer or to a third party mailer who may send targeted mailings to the addresses included in the mailing list.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g. as one or more programs running on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors for moving and/or adjusting components and/or quantities).

A typical data processing system may be implemented utilizing any suitable commercially available components, such as those typically found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 5, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1.-13. (canceled)

14. A system for gathering household consumption data at product disposal, the system comprising:
one or more identification modules configured to capture identification information associated with a disposed product at a point of disposal;
a processing module configured to:
identify the disposed product based on the captured identification information;
determine an address associated with the disposed product through one of: a manual entry, a Global Positioning Service (GPS) based automatic determination, an identifier of a disposal receptacle associated with the address, or geocoding a location of the point of disposal; and
associate a product disposal event with the determined address to obtain the household consumption data;
determine product attribute information; and
include the product attribute information in the household consumption data;
allow consumers to opt out from having their products identified at the point of disposal
and
a communication module configured to provide the household consumption data to a processing server.

15. The system of claim 14, wherein the identification modules include an optical image capture module, a barcode/QR code reader, or a Radio Frequency Identification (RFID) interrogator.

16. (canceled)

17. The system of claim 14, wherein the point of disposal is associated with one of: a personal residence, a school, a business, or a non-business entity.

18. (canceled)

19. The system of claim 14, wherein the processing module is further configured to:
include date and/or time information in the obtained household consumption data.

20.-21. (canceled)

22. The system of claim 14, wherein the processing server is further configured to:
process the household consumption data according to predefined criteria, wherein the predefined criteria includes one or more of: a type of the product, a location of the product, and a date of product collection.

23. The system of claim 22, wherein the processing server is further configured to:
process the household consumption data including one or more of data mining and performing predictive analysis.

24. The system of claim 23, wherein the processing server is further configured to:
determine a pattern of consumption habits from processing a plurality of product disposal events for the address.

25.-26. (canceled)

27. A method for gathering household consumption data, the method comprising:
receiving the household consumption data from a collection system, wherein the household consumption data is obtained by:
identifying a disposed product through one or more identification techniques at a point of disposal;
determining an address associated with the disposed product; and
associating a product disposal event with the determined address to obtain the household consumption data;
determining a household consumption behavior based on processing the household consumption data employing one or more of data mining and performing predictive analysis;
determining product attribute information;
including the product attribute information in the household consumption data;
providing the household consumption behavior to one or more entities; and
allowing consumers to opt out from having their products identified at the point of disposal.

28.-29. (canceled)

30. The method of claim 27, further comprising:
anonymizing the household consumption data.

31. The method of claim 27, further comprising:
regionalizing the household consumption data based on location regions.

32. The method of claim 31, wherein location regions include one or more of: neighborhoods, postal codes, cities, and counties.

33.-35. (canceled)

36. The method of claim 27, further comprising:
determining a change in the pattern of consumption habits for the address; and
inferring a change event for the address based on the determined change in the pattern of consumption habits.

37. The method of claim 27, wherein the entities include a business, a marketing organization, a non-governmental regulatory agency, or a government agency.

38. The method of claim 27, further comprising:
identifying one or more target consumers for a product based on the household consumption behavior.

39. The method of claim 38, further comprising:
including a list of the one or more target consumers for the product with the household consumption behavior.

40. (canceled)

41. An information processing system for gathering household consumption data, the system comprising:
a server configured to:
receive the household consumption data from a collection system that is configured to:
identify a disposed product through one or more identification techniques at a point of disposal;
determine an address associated with the disposed product; and
associate a product disposal event with the determined address to obtain the household consumption data;
determine a household consumption behavior based on the household consumption data;
anonymize the household consumption data;
provide the household consumption behavior to one or more entities;
identify one or more target consumers for a product based on the household consumption behavior;
include a list of the one or more target consumers for the product with the household consumption behavior; and
allow consumers to opt out from having their products identified at the point of disposal.

42. The information processing system of claim 41, wherein the collection system is configured to identify the disposed product through one or more identification modules including an optical image capture module, a barcode/QR code reader, or a Radio Frequency Identification (RFID) interrogator.

43. The information processing system of claim 41, wherein the point of disposal includes one of: a recycle bin or a waste bin.

44. (canceled)

45. The information processing system of claim 41, wherein the server is further configured to:
regionalize the household consumption data based on location regions.

46. (canceled)

47. The information processing system of claim 41, wherein the server is further configured to:
process the household consumption according to predefined criteria, wherein the predefined criteria includes one or more of: a type of the product, a location of the product, and a date of product collection.

48. (canceled)

49. The system of claim 47, wherein the server is further configured to:
determine a pattern of consumption habits from processing a plurality of product disposal events for the address.

50. The system of claim 49, wherein the server is further configured to:
determine a change in the pattern of consumption habits for the address; and
infer a change event for the address based on the determined change in the pattern of consumption habits.

51.-67. (canceled)
